(19) United States
(12) Patent Application Publication
(10) Pub. No.: US 2007/0296816 A1
(43) Pub. Date: Dec. 27, 2007

(54) System and method for split screen image of drawing

(76) Inventor: Jess Rubio, Windermere, FL (US)

Correspondence Address: Welsh & Katz, Ltd.;22nd Floor, 120 South Riverside Plaza, Chicago, IL, 60606-3945, US

(21) Appl. No.: 11/475,738

(22) Filed: Jun. 27, 2006

(51) Int. Cl. H04N 7/18

(52) U.S. Cl. 348/159

(57) ABSTRACT

A multi-imaging system and method is provided for use by artists in which the subject (person) being drawn by the artist can simultaneously watch themselves and the image being drawn by the artist. The user friendly multi-imaging system and method can include video cameras, a screen for viewing by the subject, and another screen for viewing by the artist.

### BACKGROUND OF THE INVENTION

This invention pertains to artwork and, more particularly, to a system and method for use by artists.

In the past, a subject (person) being drawn by an artist could not see the caricature, drawing, or other artwork until it was completed, unless the subject got up and moved to see the artwork. Furthermore, the subject was not able to see themselves and compare themselves with the artwork, let alone do so while the artwork was being drawn. This often been frustrating, disappointing and discouraging for the subject and could sometimes cause anxiety for the person being drawn.

It is, therefore, desirable to provide a system and method which overcomes most, if not all, of the preceding problems.

### BRIEF SUMMARY OF THE INVENTION

A multi-imaging (multi-image) system and method is provided for use by artists in which the subject (person) being drawn by the artist can simultaneously watch themselves and the image being drawn. Advantageously, the multi-imaging system and method is attractive, fun, easy-to-use, dependable, and effective.

In the subject-friendly method and system, an image is formed by illustrating at least part of a person (subject) on a web with a medium by an artist. The image being illustrated on the web can be a drawing, sketch, painting, and/or inking. The image being drawn on the web can be a caricature, portrait, painting, drawing, sketch, colored image, and/or black and white image. The web can be a canvass, drawing paper, paperboard, rice paper, other paper, sketch pad, cardboard, wood, or metal. The medium being used by the artist can be oil paint, acrylic, watercolors, or other paint, pastels, charcoal, graphite, chalk, crayola, marker or ink.

In the novel method and system, the image of the person (subject) being formed (drawn/illustrated) on the web is video photographed (videod) to provide a first video photograph (first live action video) with a first video camera, while simultaneously video photographing (videoing) the subject's face and/or other parts of the subject's body to provide a second video photograph (second live action video) with a second video camera. The video photograph of the image being formed (drawn/illustrated) on the web is transmitted to a first portion of a primary screen of one or more primary electronic apparatus, while simultaneously transmitting the second video photograph of the subject's face and/or other parts of the subject's body being formed (drawn/illustrated) on the web to a second portion of a primary screen of the primary electronic apparatus. Desirably, the first video photograph of the image being formed (drawn/illustrated) on the web is electronically displayed on one portion of the primary screen for viewing by the subject, while the second video photograph of the subject's face and/or other parts of the subject's body are electronically displayed on another portion of the primary screen for viewing by the subject. Advantageously, the subject can simultaneously view the first and second video photographs on the primary screen so that the subject can simultaneously see and watch themselves and the image being formed (illustrated/drawn) by the artist on the web.

The video photographing (videoing) with the first camera and/or second camera can be automatic video photographing and/or remote control video photographing. The video photographs (videos) on the primary screen can be recorded on a video tape or disc, such as a compact disc or a computer disc, and/or downloaded on the internet.

The video photographs (videos) on the primary screen can be split to form a split-screen image on the primary screen. One of the portions of the primary screen can be above, below, along side, adjacent or within the other portion of the primary screen.

The second video photograph (second video) of the face of the person (subject) being illustrated (drawn/formed) can be transmitted to one portion of a secondary screen of a secondary electronic apparatus and electronically displayed on the secondary screen for viewing by the artist to assist the artist in illustrating/drawing/forming the image on the web. The second video photograph (second video) of the image being formed (illustrated/drawn) on the web can simultaneously be transmitted to another portion of the secondary screen and displayed on the secondary screen for viewing by the artist to assist the artist in forming (illustrating/drawing) the image on the web. One portion of the secondary screen can be simultaneously electronically displayed above, below, along side, adjacent, or within the other portion of the secondary screen at a location in proximity or near the artist so that the artist can simultaneously view the first and second video photographs on the secondary screen.

In some circumstances it may be desirable to use two screens along side or adjacent each other rather than duel, multiple, or a split-screen image on a single screen.

The first and/or secondary apparatus can be a high definition (HD) monitor, video monitor, or other monitor, television, cell phone, Ipod portable media player, Blackberry mobile e-mail device, palm pilot personal digital assistant (PDA), electronic organizer, handheld device, mobile communications device, wireless apparatus, hardwired apparatus that is electronically connected by wires or cables to the cameras, central processing unit (CPU), microprocessor, labtop computer, desktop computer, personal computer, or other computer.

A more detailed explanation of the invention is provided in the following description and appended claims taken in conjunction with the accompanying drawings.

### BRIEF DESCRIPTION OF THE DRAWINGS

FIG. 1 is a perspective view of a multi-imaging system and method for use by an artist in accordance with principles of the present invention.

### DETAILED DESCRIPTION OF THE INVENTION

The following is a detailed description and explanation of the preferred embodiment and best modes for practicing the invention.

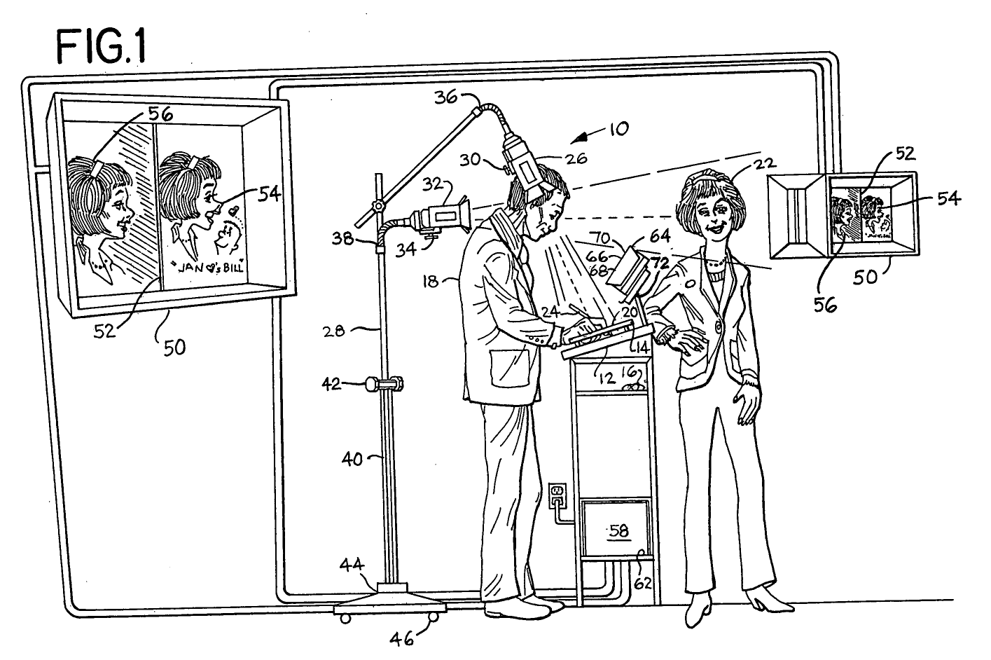

A multi-imaging (multi-image) method and system 10 (FIG. 1) for use by an artist provides a method and system for a split screen image of a drawing by which the person (subject) being drawn (illustrated, painted, or sketched) by the artist can simultaneously watch themselves and the image being drawn.

In the user and customer-friendly method and system, an artist stand 12 (FIG. 1) can be provided to support a web 14 and artist supplies 16. The artist stand can be an easle, podium, desk, or workstation. The web can be a canvass, drawing paper, paperboard, rice paper, other paper, sketch pad, cardboard, wood, or metal. The artist supplies can include at least one pallet, brush, pencil, marker, eraser, rag, cloth, wipe, paint thinner, paint remover, cleaner, solvent, sponge, swab, brush holder, cup holder, pencil box, receptacle, and/or art board.

An artist 18 (FIG. 1) can form (draw/illustrate) an image 20 comprising at least part of a person 22 (subject) on the web with a medium 24. The image can be a caricature, portrait, painting, drawing, sketch, colored image, and/or black and white image. The medium can be oil paint, acrylic, watercolors, other paint, charcoal, graphite, pastels, chalk, crayola, and/or ink.

A first camera 26 (FIG. 1) can be positioned and securely and/or moveably mounted on a portable camera stand 28 such as by a clamp 30 or other connector, to electronically photograph (video) and capture the image on the web as the image is being formed (illustrated/drawn) by the artist. A second camera 32 can be positioned and mounted on the portable and moveable camera stand by a second clamp 34 or other connector, to electronically photograph (video) and capture the face and/or other parts of the person (subject) being formed (illustrated/drawn) on the web. In the illustrated embodiment, the camera stand has an upper adjustable first arm 36 (FIG. 1) to which the first camera is secured and has a lower adjustable second arm 38 to which the second camera is secured. The camera stand can have telescoping legs 40 with a thumb screw 42 or other locking mechanism to adjust the height of the legs, arms and cameras. The legs of the camera stand can be mounted on a base 44 having casters or wheels 46.

The cameras are spaced apart from each other and can each be a video camera, motion picture camera, telephone camera, remote control camera, computer camera, and/or high definition (HD) camera.

One or more primary electronic apparatus 50 (FIG. 1) with a primary screen 52 is operatively connected, such as by wires, cables, or wireless internet connections to both the first camera and the second camera. The primary screen is positioned at a location for viewing by the person (subject) being formed (illustrated/drawn) on the web. The primary screen comprises a multiple image (multi-image) or split screen image to simultaneously display the image being formed (illustrated/drawn) on the web on a first portion 54 of the primary screen, and the face and/or other parts of the person (subject) being formed (illustrated/drawn) on a second portion 56 of the primary screen.

A video mixer 58 (FIG. 1) or other electronic device can be operatively connected, such as by wires, cables, or wireless internet connections to the primary electronic apparatus and the cameras, to facilitate splitting, separating, synchronizing, and transmission of the video photographs (videos) from the two cameras to the primary screen of the primary electronic apparatus. The video mixer can be positioned on a support surface 62 of the lower portion of the artist's stand or positioned elsewhere, if desired.

A secondary electronic apparatus 64 (FIG. 1) with a secondary screen 66 can be operatively connected, such as by wires, cables, or a wireless internet connection, to the second camera to display the face and/or other parts of the person being drawn. The secondary electronic apparatus can also be operatively connected, such as by wires, cables, or a wireless internet connection, to the first camera and video mixer, to simultaneously display the image being formed (drawn/illustrated) on one portion 68 of the secondary screen and the face and/or other parts of the person (subject) being formed (illustrated/drawn) on another portion 70 of the secondary screen. The secondary screen can comprise a split-screen image or a multiple image (multi-image) in which one image portions of the screen are positioned above, below, along side, adjacent, or within the other image portion of the secondary screen.

The secondary screen is positioned at a location for viewing by the artist. In the illustrated embodiment, the secondary screen is securely connected by a connector 72 (FIG. 1), such as by a clamp, screen support stand, pedestal, or base to the artist's stand.

The primary and secondary electronic apparatus can be a high definition (HD) monitor, video monitor, or other monitor, television, cell phone, Ipod portable media player, Blackberry mobile-mail device, palm pilot personal digital assistant (PDA), electronic organizer, handheld device, mobile communications device, wireless apparatus, hardwired apparatus electronically connected by wires or cables to the cameras, central processing unit (CPU), microprocessor, laptop computer, desktop computer, personal computer, or other computer.

In use, the artist will form an image by drawing, sketching, painting, or otherwise illustrating the face and/or other parts of a person (subject) on the web with a medium. The image being formed (illustrated/drawn) on the web is video photographed (videod) with the first video camera, while video photographing (videoing) the face and/or other parts of the person (subject) being formed (illustrated/drawn) on the web with the second video camera. The first live action video being photographed (videod) by the first video camera of the image being formed (illustrated/drawn) on the web by the artist is transmitted to a first portion (one portion) of the primary screen of the primary electronic apparatus, while simultaneously transmitting the second live action video (second video photograph) from the second video camera of the face and/or other parts of the person (subject) being formed (illustrated/drawn) on the web to the second portion (other portion) of the primary screen of the primary electronic apparatus. The two live action videos from the first and second cameras are synchronized and electronically displayed on different portions of the primary screen to provide a split screen image or multiple image (multi-image) for viewing by the person (subject) so that the person (subject) being formed (illustrated/drawn) on the web can see his/her face and/or other parts of their body concurrently and simultaneously while viewing the image being formed (illustrated/drawn) on the web by the artist.

The secondary screen of the secondary electronic apparatus can also display the face of the person (subject), as well as the image being formed (illustrated/drawn) on the web, to the artist to assist the artist in forming (illustrating/drawing) the image on the web.

Among the many advantages of the preceding multi-imaging (multi-image) method and system are:
1. Superior results.
2. Outstanding performance.
3. Enhanced drawings, paintings, caricatures, illustrations, and other artwork.
4. Exciting for the subject (person) being drawn.
5. More interesting for the subject (person) being drawn.
6. Excellent appeal to the subject (person) being drawn as well as the on-looking crowd.
7. Convenient.
8. Reliable.
9. Flexible.
10. Easy to use.
11. Portable.
12. Fun.
13. Safe.
14. Economical.
15. Efficient.
16. Effective.

Although embodiments of the invention have been shown and described, it is to be understood that various modifications and substitutions, as well as rearrangements of equipment, parts, and components, and different or other sequence of method steps and further uses of the multi-imaging (multi-image) method and system, can be made by those skilled in the art without departing from the novel spirit and scope of this invention.

What is claimed is:

1. A multi-imaging system for use by an artist, comprising:
a web selected from the group consisting of canvas, drawing paper, paper board, rice paper, paper, sketch pad, cardboard, wood, and metal;
an image of at least part of a person (subject) being formed on the web by an artist with a medium;
said image and web cooperating to provide artwork;
said image being selected from the group consisting of a caricature, portrait, painting, drawing, sketch, colored image, and black and white image;
said medium being selected from the group consisting of paint, oil paint, acrylic, watercolors, charcoal, graphite, pastels, chalk, crayola, and ink;
an artist stand for supporting said web and artist supplies;
said artist stand selected from group consisting of a easle, podium, desk, and work station;
said artist supplies selected from the group consisting of at least one palette, brush, pencil, marker, eraser, rag, cloth, wipe, paint thinner, paint remover, cleaner, solvent, sponge, swab, brush holder, cup holder, pencil box, receptacle, and art board;
a first camera for electronically photographing and capturing said image on said web as said image is being formed on said web by the artist;
a second camera for electronically photographing and capturing the subject's face and/or other parts of the subject's body;
said first camera and said second camera being positioned at different locations;
a primary electronic apparatus with a primary screen operatively connected to both said first camera and said second camera;
said primary electronic apparatus being selected from the group consisting of a monitor, high definition monitor, video monitor, television, cell phone, Ipod portable media player, Blackberry mobile e-mail device, palm pilot personal digital assistant, electronic organizer, hand held device, mobile communications device, wireless apparatus, hard wired apparatus electronically connected by wires or cables to said first and second cameras, central processing unit, microprocessor, computer, desktop computer, personal computer, and computer; and
said primary screen being positioned at a location for viewing by the subject, said primary screen displaying a split screen image or multiple images for simultaneously displaying the image being formed on the web by the artist on a first portion of said primary screen and the subject's face and/or other parts of the subject's body on a second portion of the primary screen.

2. A system in accordance with claim 1 including a video mixer operatively connected to said primary electronic apparatus and said first and second cameras.

3. A system in accordance with claim 1 including a portable camera stand for holding said first and second cameras.

4. A system in accordance with claim 1 wherein:
said cameras are spaced apart from each other; and
said cameras are each selected from the group consisting of a video camera, motion picture camera, telephone camera, remote control camera, computer camera, and high definition camera.

5. A system in accordance with claim 1 including:
a secondary electronic apparatus with a secondary screen operatively connected to said second camera for displaying the subject's face and/or other parts of the subject's body;
said secondary screen being positioned at a location for viewing by the artist; and
said secondary electronic apparatus being selected from the group consisting of a monitor, high definition monitor, video monitor, television, cell phone, Ipod portable media player, Blackberry mobile e-mail device, palm pilot personal digital assistant (PDA), electronic organizer, hand held device, mobile communications device, wireless apparatus, hard wired apparatus electronically connected by wires or cables to said second camera, central processing unit, microprocessor, laptop computer, desktop computer, personal computer, and computer.

6. A system in accordance with claim 5 wherein:
said secondary electronic apparatus is operatively connected to both said first camera and said second camera; and
said secondary screen displaying a split screen image or multiple image for simultaneously displaying the image being formed on the web by the artist on one portion of said secondary screen and the subject's face and/or other parts of the subject's body on another portion of said secondary screen.

7. A system in accordance with claim 6 wherein one of said portions of the said secondary screen is positioned above, below, along side, adjacent, or within the other of said portions of said secondary screen.

8. A system in accordance with claim 5 including:
a connector for connecting said secondary electronic apparatus to said artist stand; and
said connector selected from the group consisting of a clamp base pedestal, and support stand.

9. A system in accordance with claim 1 wherein one of said portions of said primary screen is positioned above, below, along side, adjacent, or within the other of said portions of said primary screen.

10. A multi-imaging method for use by an artist, comprising the steps of:
forming an image by illustrating at least part of a person (subject) on a web with a medium by an artist;
said illustrating being selected from the group consisting of drawing, sketching, painting, and inking;
said image being selected from the group consisting of a caricature, portrait, painting, drawing, sketch, colored image, and black and white image;
said web being selected from the group consisting of canvas, drawing paper, paper board, rice paper, paper, sketch pad, cardboard, wood, and metal;
said medium being selected from the group consisting of paint, oil paint, acrylic, watercolors, pastels, charcoal, graphite, chalk, crayola, marker, and ink;
video photographing (videoing) the image being formed on the web with a first video camera to provide a first video photograph (first video); while simultaneously
video photographing (videoing) the subject's face and/or other parts of the subject's body to provide a second video photograph (second video) with a second video camera;
transmitting the first video photograph of the image being formed on the web to a first portion of a primary screen of a primary electronic apparatus; while simultaneously
transmitting the second video photograph of the subject's face and/or other parts of the subject's body to a second portion of a primary screen of the primary electronic apparatus;
said primary electronic apparatus being selected from the group consisting of a monitor, a high definition monitor, video monitor, television, cell phone, Ipod portable media player, Blackberry mobile e-mail device, palm pilot personal digital assistant, electronic organizer, hand held device, mobile communications device, wireless apparatus, hard wired apparatus electronically connected by wires or cables to the first and second cameras, central processing unit, microprocessor, laptop computer, desktop computer, personal computer, and computer;
electronically displaying the first video photograph of the image being formed on the web on the first portion of the primary screen; while simultaneously
electronically displaying the second video photograph of the subject's face and/or other parts of the subject's body on the second portion of the primary screen; and
viewing the electronically displayed first video photograph of the image by the subject on the first portion of the primary screen; while the subject simultaneously
views the electronically displayed second video photograph of the subject's face and/or other parts of the subject's body on the second portion of the primary screen.

11. A method in accordance with claim 10 wherein said video photographing with said first camera comprises automatic video photographing with said first camera.

12. A method in accordance with claim 10 wherein said video photographing with said second camera comprises automatic video photographing (videoing) with said second camera.

13. A method in accordance with claim 10 wherein said video photographing with at least one of said cameras comprises remote control video photographing (videoing).

14. A method in accordance with claim 10 including splitting the first and second video photographs on the primary screen to form a split-screen image on the primary screen.

15. A method in accordance with claim 10 including positioning one of the portions of the primary screen above, below, along side, adjacent, or within the other portion of the primary screen.

16. A method in accordance with claim 10 including positioning the primary screen near the subject so that the subject can see the primary screen.

17. A method in accordance with claim 10 including simultaneously recording the first and second video photographs on the primary screen on a disc or tape.

18. A method in accordance with claim 10 including:
transmitting the second video photograph (second video) of the subject's face and/or other parts of the subject's body to one portion of a secondary screen of a secondary electronic apparatus;
said secondary electronic apparatus being selected from the group consisting of a monitor, high definition monitor, video monitor, television, cell phone, Ipod portable media player, Blackberry mobile e-mail device, palm pilot personal digital assistant, electronic organizer, hand held device, mobile communications device, wireless apparatus, hard wired apparatus electronically connected by wires or cables to the second camera, central processing unit, microprocessor, laptop computer, desktop computer, personal computer, and computer; and
electronically displaying the second video photograph (second video) of the subject's face and/or other parts of the subject's body on said secondary screen for viewing by the artist to assist the artist in forming the image on the web.

19. A method in accordance with claim 18 including:
transmitting the first video photograph (first video) of the image being formed on the web to another portion of the secondary screen; and
electronically displaying the first video photograph (first video) of the image being formed on the web to another portion of the secondary screen for viewing by the artist to assist the artist in forming the image on the web.

20. A method in accordance with claim 19 including:
simultaneously electronically displaying one portion of the secondary screen above, below, along side, adjacent, or within the other portion of the secondary screen near the artist; while the artist
simultaneously views the first and second video photographs electronically displayed on the secondary screen.
